(19) United States
(12) Patent Application Publication
(10) Pub. No.: US 2026/0241348 A1
(43) Pub. Date: Aug. 20, 2026

(54) NOVEL NANOBUBBLE GENERATOR FOR HYDROPONIC, AQUAPONIC, OPEN-FIELD AGRICULTURE, AND/OR CELLULAR AGRICULTURE SYSTEMS

(71) Applicant: NANU WATER TECHNOLOGY, INC., Lynnwood, WA (US)

(72) Inventors: Chien-Chang Kung, Seattle, WA (US); Seth Connell, Lynwood, WA (US)

(21) Appl. No.: 19/445,497

(22) Filed: Jan. 10, 2026

Related U.S. Application Data
(63) Continuation of application No. PCT/US2025/016497, filed on Feb. 19, 2025.

(51) Int. Cl. B01F 23/2375; B01F 23/2326; B01F 23/237; B01F 25/312; B01F 101/00

(52) U.S. Cl. CPC B01F 23/2375; B01F 23/2326; B01F 23/237611; B01F 25/3122; B01F 25/31232; B01F 2101/305; B01F 2215/0431; B01F 2215/044

(57) ABSTRACT

In some respects there is provided a novel nanobubble generator, which can be used, for example, to enhance water used in hydroponic, aquaponic, open-field agriculture, cellular agriculture systems, pools and/or spas.

### BACKGROUND

While microbubble and nanobubble generators are known, they are typically cumbersome designs, do not efficiently generate nanobubbles, and/or are not adaptable for various uses (e.g., as an underwater nanobubble generator).

US20210154626 describes a microbubble generator that can be used to attach to or modify a faucet (or shower head). However, there is no mention of generating nanobubbles, supplying a gas other than ambient, or being able to use such a generator underwater.

WO2020028646 illustrates a nanobubble expanding apparatus that first makes nanobubbles and then expands them to form microbubbles (1-50 μm) which appear to be useful for removing contaminants from water.

US20200289992 depicts a submersible nanobubble generator that uses a motor and a rotatable shaft. This generator on top of requiring complicated components such as the motor and drive shaft also requires a source of compressed gas (e.g., air delivered via a pump).

US20200003506 mentions an apparatus for generating nanobubbles that requires both the use of a gas permeable membrane as well as a source of pressurized gas.

US20210299617 relates to a nanobubble generating apparatus that uses a gas source (compressed gas), a gas diffuser, and a funnel to generate nanobubbles in a moving liquid (e.g., river or stream). It appears that the nanobubbles generated by this apparatus are based on the flow of the moving liquid, with little to no operator control.

In view of the above, it would be useful to discover a nanobubble generator that does not require pressured gas, sensitive membranes, or the use of moving parts, but still can generate large quantities of nanobubbles.

### BRIEF SUMMARY OF THE INVENTION

In some aspects, is provided a novel nanobubble generator, comprising: a housing, a liquid inlet, a liquid outlet, a gas inlet, a mixing chamber, and in some aspects a porous medium, configured to create cavitation and mechanical agitation.

In some aspects, the novel nanobubble generator is configured to operate underwater.

In some aspects, the novel nanobubble generator is used to create nanobubble compositions (e.g., water and ambient air nanobubbles) that can be used in hydroponic, aquaponic, open-field agriculture, and/or cellular agriculture systems.

The capabilities of the elements comprising the present invention are not limited to those described herein and may include others that may or may not be related to those that have already been described.

### BRIEF DESCRIPTION OF THE DRAWINGS

FIGS. 1A-B: FIG. 1A shows an internal cutaway view of a part of a nanobubble generator of the present invention. FIG. 1B shows an internal cutaway partial view of a part of a nanobubble generator of the present invention.

FIGS. 2A-B: FIG. 2A shows a diagram of a nanobubble generator. FIG. 2B shows a 3D cutaway of a nanobubble generator.

FIGS. 3A-B: FIG. 3A is an exploded order of assembly view for a nanobubble generator.

FIG. 3B is a 3D rendering with exterior wall removed of a nanobubble generator.

FIGS. 4A-C show an example of a nanobubble generator assembled, a housing, and a housing with cap, respectively.

FIG. 5 shows a diagram of an in-line nanobubble generator.

FIG. 6 shows a 3D rendering with an exterior wall removed.

FIG. 7 shows a diagram of an in-line nanobubble generator with an optional barbed hose fitting and gas sleeve for receiving any selected compressed gas.

FIGS. 8A-B: FIG. 8A shows an assembled in-line nanobubble generator connected to couplings (e.g., for irrigation). FIG. 8B shows an assembled in-line nanobubble generator connected to a clear hose from an air compressor.

FIG. 9 is an exploded order of assembly for an in-line nanobubble generator.

FIG. 9 shows an “in-reservoir” configuration, wherein the nanobubble generator is located in a reservoir external to the hydroponic chamber. This generator can be configured to draw ambient gas or a selected gas.

FIG. 10 shows an “in-line” reservoir configuration, wherein the nanobubble generator is located in a hydroponic irrigation system. The generator in this configuration typically has a gas line to feed gas to it (e.g., ambient or other gas).

FIGS. 11A-E: FIG. 11A shows an in-line nanobubble generator with a female gas barb.

FIG. 11B is a top view of an in-line nanobubble generator with a female gas barb. FIG. 11C is a cutaway top view of an in-line nanobubble generator with a female gas barb. FIG. 11D is a cutaway side view of an in-line nanobubble generator with a female gas barb. FIG. 11E is a perspective view of an in-line nanobubble generator with a female gas barb.

FIGS. 12A-E: FIG. 12A shows an in-line nanobubble generator with a male gas barb.

FIG. 12B is a top view of an in-line nanobubble generator with a male gas barb. FIG. 12C is a cutaway top view of an in-line nanobubble generator with a male gas barb. FIG. 12D is a cutaway side view of an in-line nanobubble generator with a male gas barb. FIG. 12E is a perspective view of an in-line nanobubble generator with a male gas barb.

### DETAILED DESCRIPTION OF THE INVENTION

All references cited herein are hereby incorporated in their entirety herein by reference.

In describing the invention, it will be understood that a number of techniques and steps are disclosed. Each of these has individual benefits and each can also be used in conjunction with one or more, or in some cases, all of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims. Headings are provided for convenience only and are not to be construed to limit the invention in any way. Aspects or embodiments illustrated under any heading may be combined with aspects or embodiments illustrated under any other heading.

The present disclosure is to be considered as an exemplification of the invention and is not intended to limit the invention to the specific embodiments illustrated by the figures or description included herein.

In the following description, for purposes of explanation, numerous specific details are set forth to provide a thorough understanding of the present invention. It will be evident, however, to one skilled in the art that the present invention may be practiced without these specific details.

### Terminology

The terminology used herein is for the purpose of describing particular embodiments only and is not intended to be limiting of the invention. As used herein, the term “and/or” includes any and all combinations of one or more of the associated listed items. As used herein, the singular forms “a”, “an”, and “the” are intended to include the plural forms as well as the singular forms, unless the context clearly indicates otherwise.

The phrase “at least one of”, when combined with a list of items, means a single item from the list or any combination of items from the list. The phrase does not require all of the listed items unless explicitly so defined.

“In-reservoir” refers to a configuration where the air inlet of the generator is exposed (in part or in whole) to the atmosphere (for ambient gas) or a gas source.

“In-line” refers to a configuration where the generator is submerged in water (e.g., underwater) and is connected to a source of ambient or gas.

Ambient (or ambient gas or ambient air) refers to the air or atmosphere surrounding the generator.

Gas (distinct from ambient gas) refers to a specific gas (or mixture of gases) that is fed to the generator. Examples include oxygen and nitrogen.

Aquaponics refers to the controlled cultivation of plants, fish, beneficial microorganisms, and sometimes fruiting fungi in a closed-loop hydroponics system.

Hydroponics refers to the controlled cultivation of plants and sometimes beneficial microorganisms in a closed-loop recirculating irrigation system.

Open-field agriculture refers to the controlled cultivation of plants in soil or another prepared medium.

Cellular agriculture refers to the controlled cultivation of plant and/or animal cells in a laboratory setting.

Animal husbandry refers to the controlled cultivation of fauna, whether terrestrial, aquatic, or amphibious.

Deep water culture refers to the controlled cultivation of plants on floating rafts of varying composition within containers of standing water that may or may not be continually aerated with ambient air or oxygen.

Ebb and flow system refers to the controlled cultivation of plants within a container of porous media with a fluctuating water table that fills and drains as fed from a water pump that may or may not be set on a timer.

Extraction refers to the post-harvest practice of removing derivative substances (granular solids, oils, and/or liquids) from plant material for the purposes of separation and consolidation.

Slip fitting or slip joint refers to a fitting configured to allow a pipe to slide onto it. The joint can be held in place by friction. Optionally an adhesive or another mechanical assist (e.g., bolt or screw) is used to maintain the integrity of the joint.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

### DESCRIPTION

The present invention will now be described by referencing the appended figures.

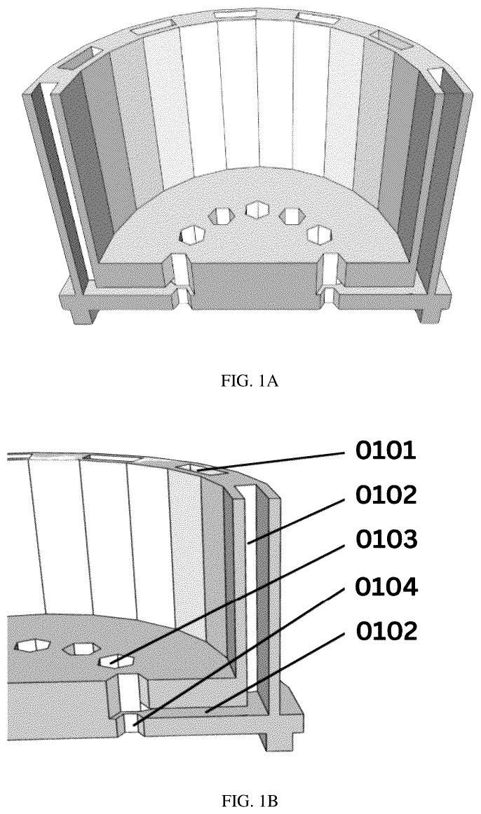

The following reference numbers are in one or more of FIGS. 1B, 1B, 2A, 2B, 5, 6, and 7.

| | |
|---|---|
| 0101 | air inlet |
| 0102 | air inlet channel |
| 0103 | hexagonal cavity |
| 0104 | hexagonal water inlet |
| 0201 | gas inlet |
| 0202 | exit orifice |
| 0203 | liquid outlet |
| 0204 | liquid inlet |
| 0205 | gas outlet |
| 0206 | liquid source |
| 0207 | mixing chamber |
| 0501/0601 | gas inlets |
| 0502/0602 | exit orifice |
| 0503/0603 | mixing channels |
| 0504/0604 | liquid channels |
| 0505/0605 | female thread |
| 0506/0606 | liquid source |
| 0507/0607 | mixing chamber |
| 0701 | barbed hose fitting |
| 0702 | circumferential gas sleeve |

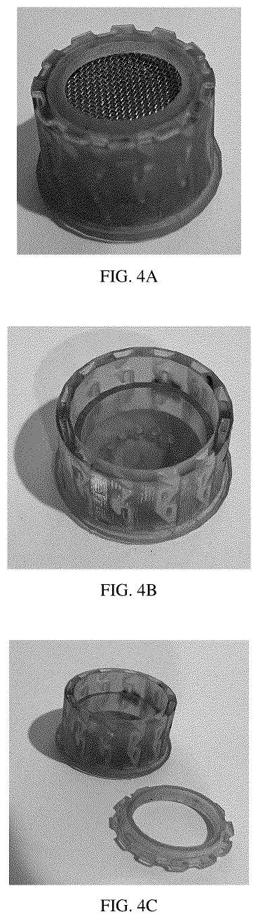

In some aspects, there is provided a nanobubble generator in a faucet-like configuration (see FIG. 1.A-FIG. 4.C), comprising:
a) a housing, comprising: a substantially closed bottom, a substantially open top, and a wall that circumscribes an interior portion, the housing, further comprising:
   i) a series of liquid channels, comprising: an inlet located in the bottom of the housing and an outlet located in the interior of the housing;
   ii) a series of gas channels located in the wall of the housing, comprising: an inlet located in the top or side of the housing and an outlet located in the liquid channel; and,
   iii) a series of mixing channels that induce Venturi based cavitation located in parallel succession to corresponding liquid channels and also in adjacent succession to corresponding gas channels so as to provide a confined path for liquid and gas to mix;
b) optionally, a porous medium housed near the bottom of the housing and positioned adjacent to the mixing chamber; and,
c) optionally, an endcap configured to attach to the housing and fasten the porous medium in place.

In some aspects, mixing channels may range from at least 10%, 20%, 30%, 40%, 50%, 60%, 70%, 80%, 90%, 100% or more larger in diameter than the liquid channels.

In some aspects, the bottom and wall of the housing form a closed ended cylinder (see FIG. 4B). In these aspects, the endcap is configured to enclose the open end of the cylinder (see FIGS. 4A and C).

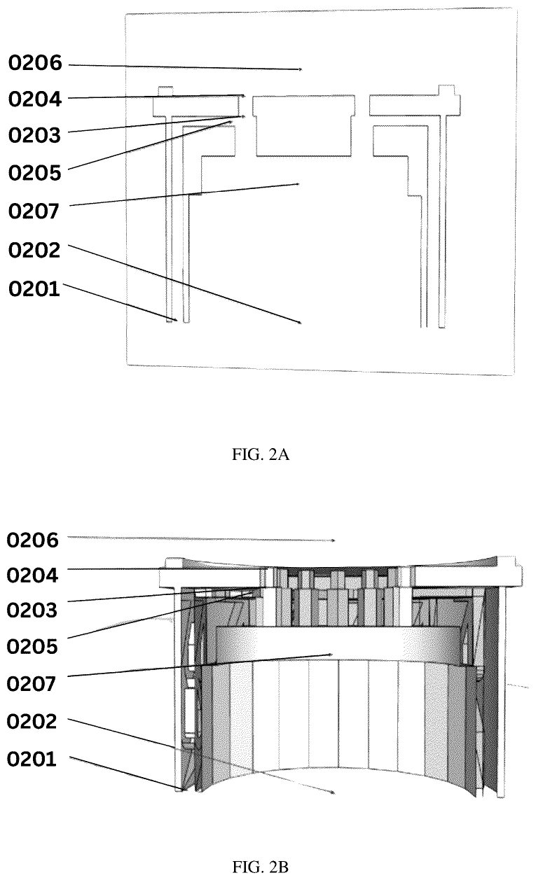

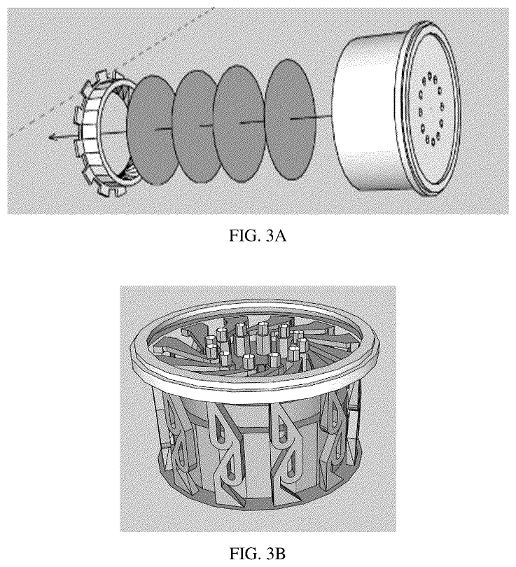

In some aspects, the housing, comprises: a plurality of liquid and gas channels (see FIGS. 2B and 3B). In some aspects, each gas channel is in communication with a different liquid channel, thereby forming a gas channel-liquid channel pair.

In some aspects, the gas channel, further comprises: a valvular conduit such as those described in U.S. Pat. No. 1,329,559 (Tesla). The valvular conduit is intended to prevent liquid from escaping the housing.

In some aspects, the endcap is configured with an opening or openings that correspond to the gas inlet or gas inlets, respectively (see FIG. 3A and FIG. 4C).

In some aspects, as shown in FIGS. 4A and C, the endcap is mechanically attached to the housing, e.g., via a threading (e.g., screw on cap), adhesive, or mechanical locking configuration (e.g., the cap snaps onto or into the housing). In some aspects, a slip fitting or slip joint is used (which can be held together via friction and/or an adhesive).

In some aspects, the porous medium fits into the housing (see FIG. 4A). For example, when the housing is cylindrical, the medium can be circular with a diameter slightly less than the interior diameter of the housing. In some aspects, the porous medium is affixed to the interior of the housing (e.g., via adhesive, thread, or other form of tamper-proof locking). In some aspects, the porous medium fits into the interior of the housing but is not affixed thereto. In these aspects, the endcap is used to keep the porous medium in place.

In some aspects, the generator, comprises: a plurality of porous media. Examples include 2, 3, 4, 5 or more porous media (see FIG. 3A).

In some aspects, the porous medium is a micro screen having a plurality of pores (see FIG. 4A). Examples of pore diameters include diameters less than 200, 190, 180, 170, 160, 150, 140, 130, 120, 110, 110, 90, 80, 70, 60, 50, 40, 30, to 20 μm. In some aspects, the porous medium is plastic or metal (e.g., stainless steel).

FIG. 2B shows a mixing chamber, comprising a cavity between the liquid inlet and the porous medium. Cavitation and the inter-mixing of liquid, gas, and nanobubbles is expected to take place in this cavity.

FIGS. 3A and 4A show an example of a nanobubble generator in a faucet-like configuration. In these figures, a single attachment point on the bottom of the generator is shown (e.g., the threaded portion). Liquid (e.g., water with or without nutrients) enters the bottom of the generator (e.g., through the inside of the threaded section) and then exits as a liquid/nanobubble mixture through the endcap. This discharge can be directed wherever desired. In this configuration, the gas (e.g., ambient) is drawn in from the top of the generator (e.g., through or around the endcap).

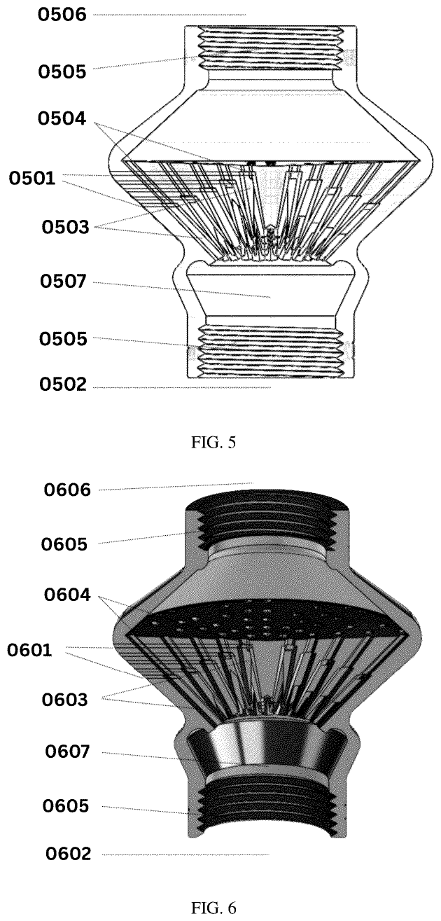

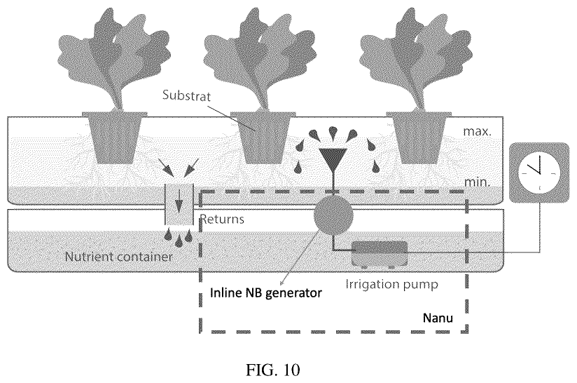

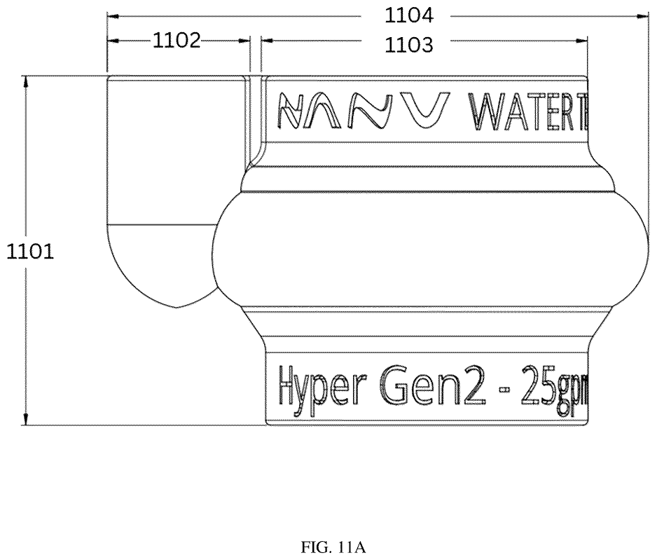

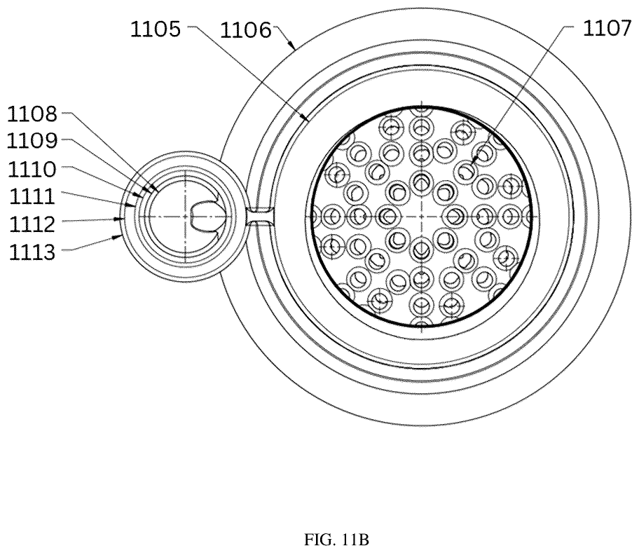

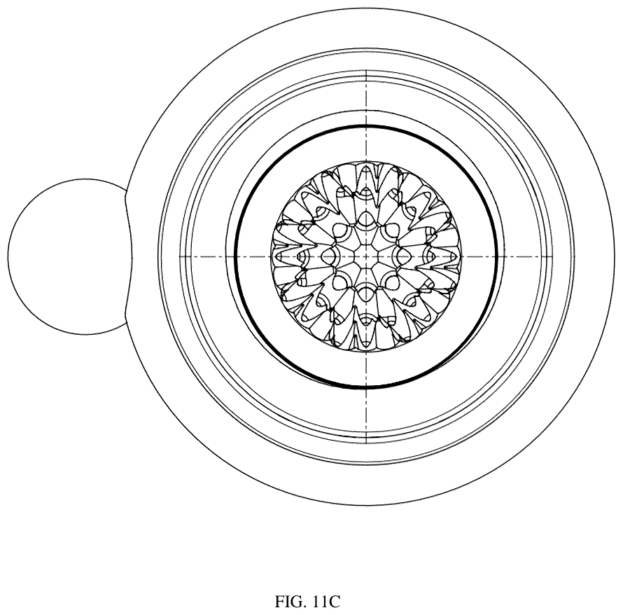

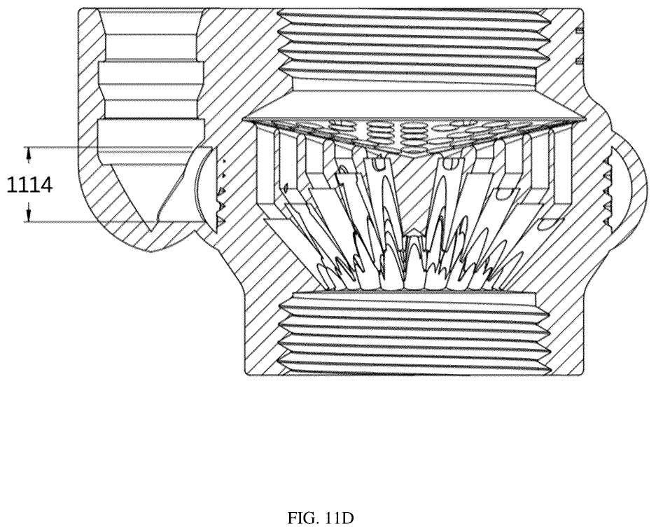

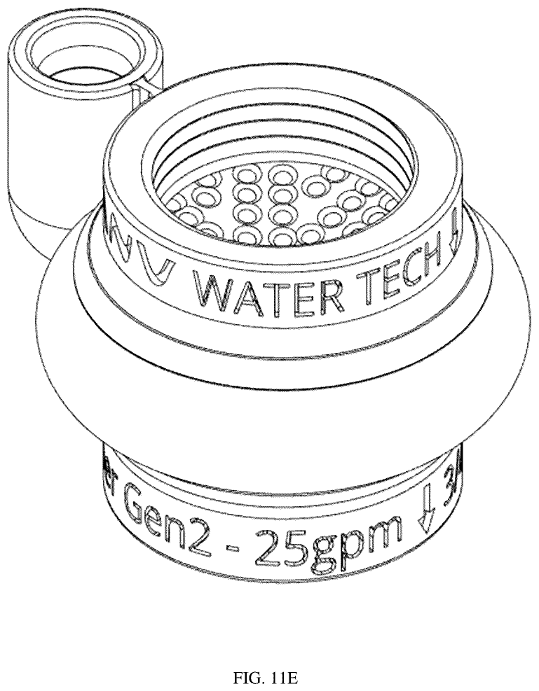

In some aspects, there is provided a novel nanobubble generator in an in-line configuration (e.g., see FIGS. 5-12E) comprising;
a) an inlet for a liquid source (e.g., water), the inlet optionally comprising:
   1) threading (e.g., male or female to attached a pipe or hose to deliver liquid to the generator);
b) a housing, comprising: a top, a bottom, and a wall that circumscribes an interior portion, the interior portion, further comprising:
   i) an upper chamber, comprising:
      1) a top in fluid communication with the inlet;
      2) a fluid reservoir; and,
      3) a bottom, comprising: a plurality of liquid openings (to divide the incoming liquid into a plurality of streams);
   ii) a lower chamber, comprising:
      1) a plurality of mixing channels housed therein, the mixing channels are substantially parallel to each adjacent mixing channel and are angled inward (from inlet to the outlet) and the mixing channels are configured to induce venturi cavitation and to provide a confined path for liquid and gas to mix, each mixing channel, comprises:
         a) a liquid inlet in fluid communication with one of the liquid openings of the upper chamber bottom;
         b) a gas inlet; and,
         c) an outlet;
   iii) at least one gas opening through the housing wall configured to be in gas communication with each gas inlet of the lower chamber:
   iv) a mixing chamber located below the lower chamber and configured to receive the output from the plurality of mixing channel outlets (i.e., a mixture of gas and liquid), the mixing chamber, further comprising:
      1) a top in liquid and gas communication with the mixing channel outlets;
      2) a body configured to mix the liquid and gas received from the mixing channel outlets;
      3) a bottom;
c) an outlet configured to receive the contents of the mixing chamber, the outlet optionally comprising:
   1) threading (e.g., male or female to attached a pipe or hose to deliver liquid to the generator).

In some aspects, the angle of entry of and the spacing of the mixing channels are configured for the output of all mixing channels to collide in the mixing chamber and the collision of the mixing channel output is a single point collision resulting in a singular direction output.

In some aspects, the angle of entry of and the spacing of the mixing channels are configured for the output of all mixing channels to collide in the mixing chamber and the collision of the mixing channel output is a multiple point collision resulting in a rotating output.

In some aspects, the angles of collision between liquid streams leaving the mixing channels that enter the mixing chamber may be adjusted to generate a wider or narrower combined exit stream that leaves the mixing chamber.

In some aspects, a plurality of collision points may be arranged geometrically to generate a rotating combined exit stream instead of a straight flowing combined exit stream that typically results from a single point collision of liquid streams.

In some aspects, the housing, comprises: a singular gas opening.

In some aspects, the gas opening, further comprises:
a) a gas inlet fitting located on the exterior of the housing and in gas communication with the gas opening; and,
b) a circumferential gas sleeve configured to be in gas communication with the gas opening and each of the mixing chamber gas inlets.

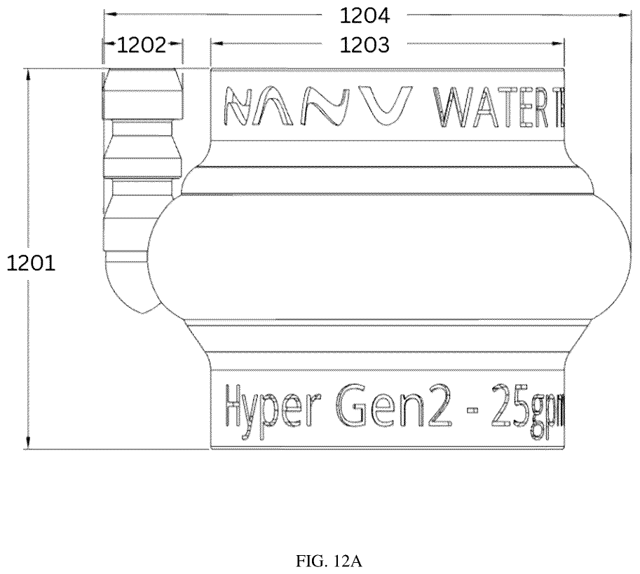

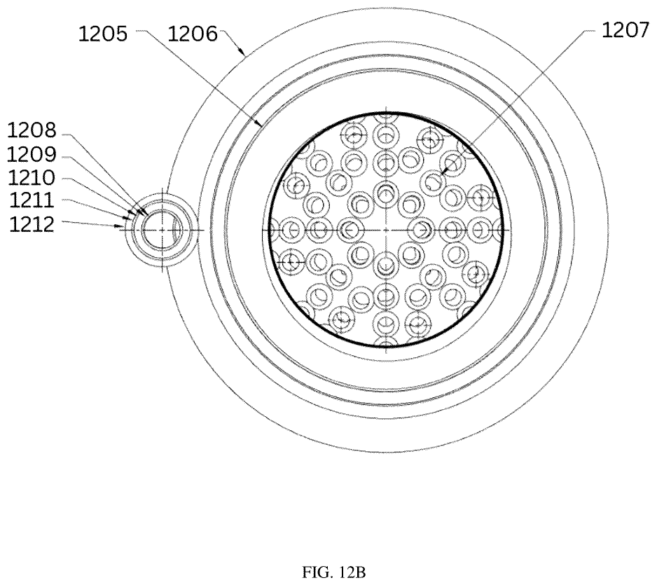

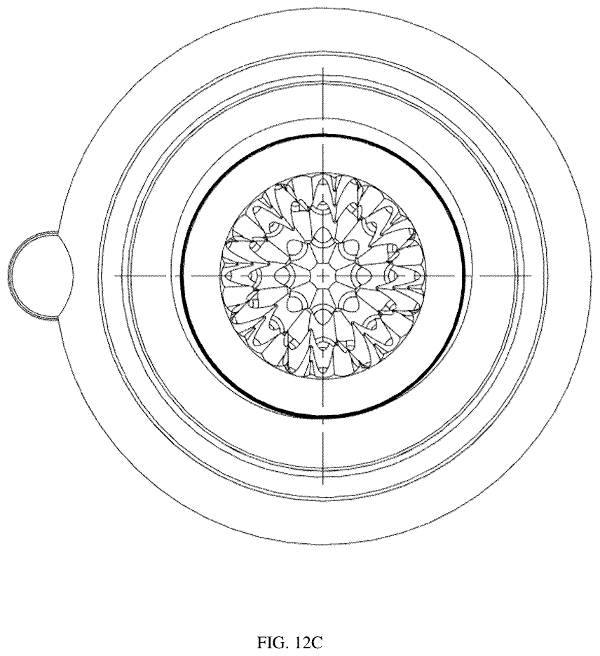

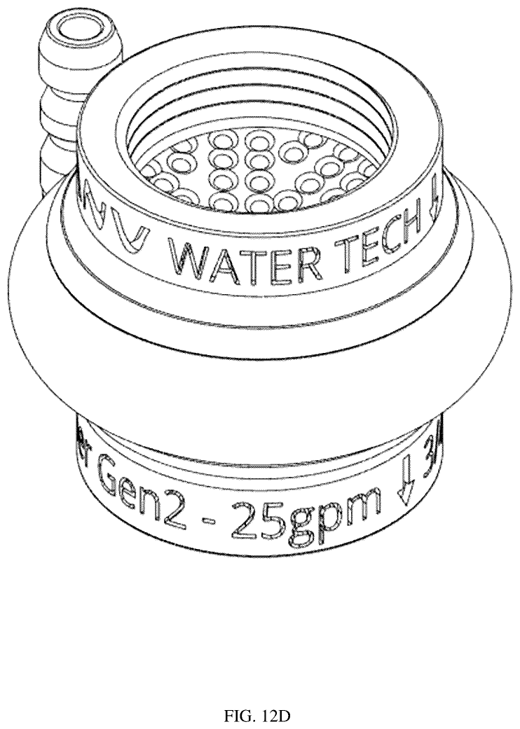

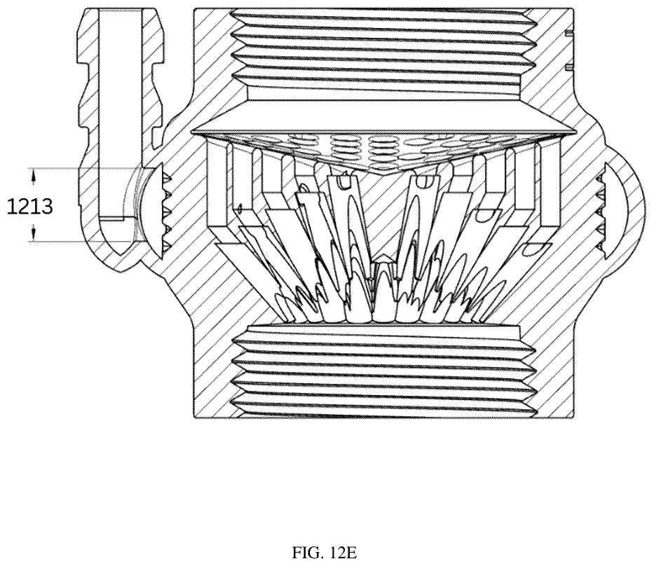

In some aspects, the gas inlet fitting, comprises a barbed hose fitting. Examples of barbed fittings include female barbs (e.g., FIGS. 11A-E), male barbs (e.g., FIGS. 12A-E), and threaded connections (not shown).

In some aspects, the housing, comprises: a plurality of gas openings.

In some aspects, the gas opening, further comprises:
a) a gas channel connecting each opening with a mixing channel.

In some aspects, the top of the mixing chamber has a substantially convex conical shape (with the narrow/pointed middle toward the lower chamber).

In some aspects, the generator is in an in-line configuration.

In some aspects, the inlet and outlet each, independently, comprise: threading.

In some aspects, the liquid openings in the bottom of the upper chamber are substantially equidistant from one another.

In some aspects, the liquid openings in the bottom of the upper chamber are evenly spaced substantially throughout the bottom.

In some aspects, the attachment point is threading (e.g., male or female threads) (see FIGS. 5 and 6).

In some aspects, mixing channels may range from at least 10%, 20%, 30%, 40%, 50%, 60%, 70%, 80%, 90%, 100% or more larger in diameter than the liquid channels.

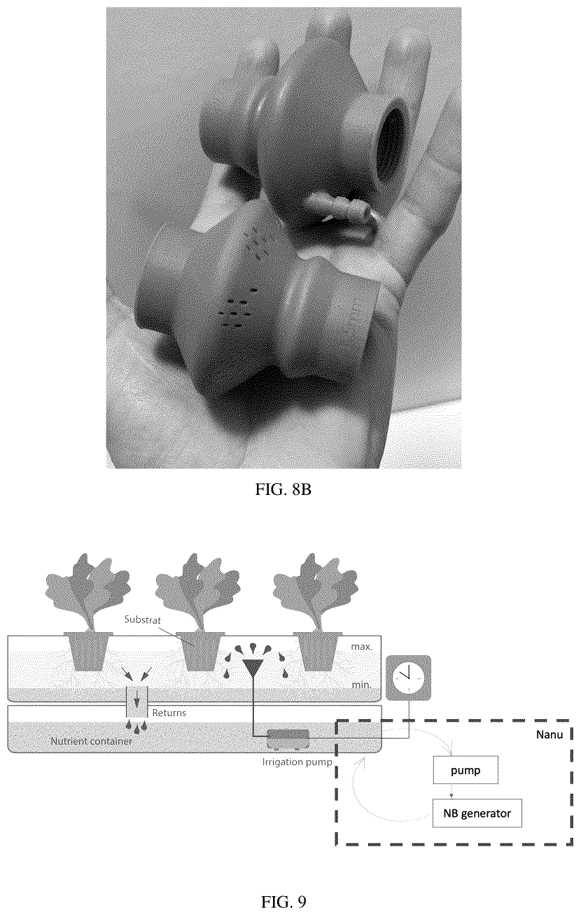

FIGS. 5, 6, 7, and 8A-B show an example of a nanobubble generator in an in-line configuration. FIG. 8B shows two generators; one with a gas sleeve and gas port, and one generator without that draws in ambient gas. Like in the faucet-like configuration, the liquid enters the top of the generator and then exits through the bottom (e.g., through the threaded bottom). The discharge in this configuration is typically directed through a pipe attached to the bottom of the generator (see FIG. 8A). Like in the faucet-like configuration, the gas (e.g., ambient) is drawn in from the sides of the generator (e.g., through or around the endcap).

In some aspects, the nanobubble generator is in an in-line configuration and the top of the housing, further comprises an attachment point to secure the generator to a liquid source (e.g., water piper) and the bottom of the generator, further comprises an attachment point to secure the generator to an exit pipe. In some aspects, the attachment point is threading (e.g., male or female threads) (see FIGS. 5, 6, 7, 8A, and 8B).

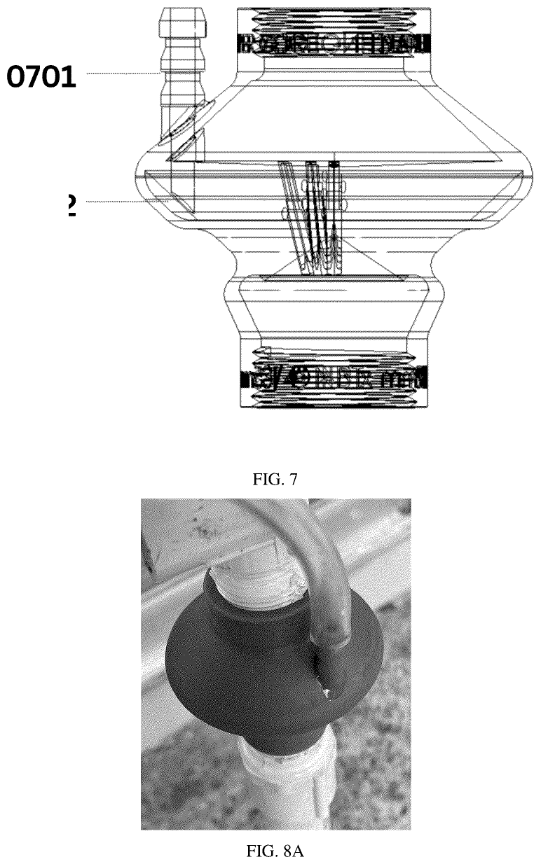

In some aspects, the in-line nanobubble generator is outfitted with a gas sleeve. In this aspect, the presence of the gas sleeve allows the in-line generator to be submerged (e.g., used under water). This allows a source of gas to be connected to the generator via a pipe or tubing (see FIGS. 7 and 8B).

In FIGS. 11A-E, examples of dimensions (mm) for an in-line nanobubble generator with a female gas barb are shown in the table below. Other dimensions can be used. In another example, the dimensions are a multiple of those shown (e.g., 1.1, 1.2, 1.3, 1.4, 1.5, 1.6, 1.7, 1.8, 1.9, 2, 3, 4, 5, 6, 7, 8, 9, 10× or more) or a fraction of those shown (e.g., 0.9, 0.8, 0.7, 0.6, to 0.5× or less).

| | |
|---|---|
| 1101 | 36.24 |
| 1102 | 14.41 |
| 1103 | 46.07 |
| 1104 | 56.28 |
| 1105 | 32.5 |
| 1106 | 46.07 |
| 1107 | 1.73 |
| 1108 | 7.96 |
| 1109 | 9 |
| 1110 | 10.21 |
| 1111 | 11.18 |
| 1112 | 13.41 |
| 1113 | 14.14 |
| 1114 | 7.36 |

In FIGS. 12A-E, examples of dimensions (mm) for an in-line nanobubble generator with a male gas barb are shown in the table below. Other dimensions can be used. In another example, the dimensions are a multiple of those shown (e.g., 1.1, 1.2, 1.3, 1.4, 1.5, 1.6, 1.7, 1.8, 1.9, 2, 3, 4, 5, 6, 7, 8, 9, 10× or more) or a fraction of those shown (e.g., 0.9, 0.8, 0.7, 0.6, to 0.5× or less).

| | |
|---|---|
| 1201 | 36.24 |
| 1202 | 7.63 |
| 1203 | 46.07 |
| 1204 | 50.08 |
| 1205 | 32.5 |
| 1206 | 46.07 |
| 1207 | 1.73 |
| 1208 | 3.8 |
| 1209 | 3.85 |
| 1210 | 6.1 |
| 1211 | 6.16 |
| 1212 | 7.63 |
| 1213 | 7.36 |

In some aspects, the nanobubble generator is in an in-line configuration and the generator, further comprises:
a) a gas sleeve in gas communication with one or plural gas inlets.

In some aspects, the gas sleeve is configured as an integral part of the housing (e.g., the housing and sleeve are a continuous unit).

In some aspects, a generator configured with a gas sleeve is capable of being used underwater. In these aspects, the gas sleeve can be connected to a gas source via piping or tubing. This allows the generator to be submerged as the gas is delivered to the generator. In some aspects, the gas sleeve is in gas communication with a plurality of gas inlets.

In some aspects the gas sleeve further comprises: a gas port. In other aspect, the gas sleeve further comprises: a plurality of gas ports. The gas port or ports can be in gas communication with one or more gas inlets.

In some aspects, the inflow of gas through the gas channel is in an adjacent direction of the discharge from the generator.

In some aspects, the inflow of liquid through the liquid channel is in the same direction of the discharge from the generator.

In some aspects, there is provided a generator, further comprising:
c) a water pump in liquid communication with the liquid channel, wherein the pump creates sufficient pressure in the generator to generate nanobubbles.

In some aspects, there is provided a generator, further comprising:
d) a reservoir; and,
e) a first pipe in liquid communication with the pump and the reservoir and configured to withdraw liquid from the reservoir and deliver it to the generator.

In some aspects, the gas source is ambient air; in other aspects, the gas source is compressed air, oxygen, ozone, nitrogen, carbon dioxide, or other singular gas phase compounds. In other aspects, the gas source is a combination of compressed gasses.

In some aspects, the generator is configured to discharge water, comprising: at least 50, 100, 150, 200, 250, 300, 350, 400, 450, 500, 550, 600, 650, 700, 750, 800, 850, 900, 950, to 1000M/ml or more nanobubbles (M/mL=millions of bubbles/mL).

In some aspects, the diameters of the nanobubbles range from (a) 10 to 1000 nm, (b) 100 to 200 nm and (c) 10, 20, 30, 40, 50, 60, 70, 80, 90, 100, 200, 300, 400, 500, 600, 700, 800, 900, to 1000 nm. In some aspects, these diameters range from 100, 110, 120, 130, 140, 150, 160, 170, 180, 190, to 200 nm. In some aspects at least 40, 50, 60, 70, to 80% or more of the nanobubbles have diameters within the recited range (e.g., 80-200 nm). At least two different methods can be used to determine the nanobubble profile/distribution: 1) Nanoparticle Tracking Analysis (NTA); and, 2) Dynamic Light Scattering (DLS).

In some aspects, at least 25, 30, 35, 40, 45, 50, 55, 60, 65, 70, to 75% or more of the nanobubbles generated remain in solution for at least 24 to 48 hours or more.

In some aspects, these novel nanobubble generators are designed with the intention of being produced using additive manufacturing technologies, thus allowing for their composition to be customizable as it were to pertain to their use-case. The composing materials may be but are not limited to photosensitive polymers, metal alloys, elastomers, or more.

In some aspects, the generator is suitable for use in a hydroponic system, in an aquaponic system, in deep water culture, in an ebb and flow system, and/or with animal husbandry.

In some aspects, the growth of plants exposed (e.g., in a hydroponic system) to the nanobubbles increases by 1, 2, 3, 4, 5, 6, 7, 8, 9, 10, 11, 12, 13, 14, 15, 16, 17, 18, 19, 20, 21, 22, 23, 24, 25, 26, 27, 28, 29, to 30% or more compared to similar plants exposed to water not enhanced with nanobubbles. Plant growth is typically measured by weighing the plants and comparing the weight of treated (exposed to nanobubbles) versus untreated plants. Other factors that might contribute to plant growth enhancement include the following, which will need to be considered:
a. the type of gas (e.g., ambient v. oxygen);
b. type of plant;
c. concentration of nanobubbles;
d. size distribution profile of nanobubbles;
e. type of nutrient solution or absence thereof;
f. dissolved oxygen in the nutrient reservoir and when it's delivered to the plants;
g. pH of nutrient solution;
h. relative humidity of the growing environment;
i. vapor pressure deficit of the growing environment;
j. Surface tension value of the water;
k. CO₂ in the ambient; and,
l. lighting (e.g., spectrum, intensity, and duration).

In some aspects, the nanobubble solutions of the present invention can be used for wastewater treatment through flocculation, disinfection for cleaning surfaces, growth promotion of aerobic bacteria, and/or growth suppression of algae through oxygen and/or ozone aeration.

In some aspects, the nanobubble solutions of the present invention may be used for extracting derivatives of agricultural products which may include but isn't limited to granular compounds, oil compounds, or liquid compounds.

In some aspects, the nanobubble solutions of the present invention can be used for cellular agriculture for the purposes of improving cellular performance which may include but is not limited to the yield coefficient, feed conversion ratio, mass balance, cell proliferation rate, provision of oxygen in cell culture media, and more.

Although the present invention has been illustrated and described herein with reference to possible aspects, configurations, embodiments, and specific examples thereof, it will be readily apparent to those of ordinary skill in the art that other configurations, embodiments, and examples may perform similar functions and/or achieve like results. All such equivalent configurations, embodiments and examples are within the spirit and scope of the present invention, are contemplated thereby, and are intended to be covered by the following claims.

1. A nanobubble generator, comprising:
a) an inlet for a liquid source:
b) a housing, comprising: a top, a bottom, and a wall that circumscribes an interior portion, the interior portion, further comprising:
i) an upper chamber, comprising:
1) a top in fluid communication with the inlet;
2) a fluid reservoir; and,
3) a bottom, comprising: a plurality of liquid openings (to divide the incoming liquid into a plurality of streams);
ii) a lower chamber, comprising:
1) a plurality of mixing channels housed therein, the mixing channels are substantially parallel to each adjacent mixing channel and are angled inward and the mixing channels are configured to induce venturi cavitation and to provide a confined path for liquid and gas to mix, each mixing channel, comprises:
a) a liquid inlet in fluid communication with one of the liquid openings of the upper chamber bottom;
b) a gas inlet; and,
c) an outlet;
iii) at least one gas opening through the housing wall configured to be in gas communication with each gas inlet of the lower chamber:
iv) a mixing chamber located below the lower chamber and configured to receive the output from the plurality of mixing channel outlets, the mixing chamber, further comprising:
1) a top in liquid and gas communication with the mixing channel outlets;
2) a body configured to mix the liquid and gas received from the mixing channel outlets;
3) a bottom;
c) an outlet configured to receive the contents of the mixing chamber.

2. The generator of claim 1, wherein the angle of entry of and the spacing of the mixing channels are configured for the output of all mixing channels to collide in the mixing chamber and the collision of the mixing channel output is a single point collision resulting in a singular direction output.

3. The generator of claim 1, wherein the angle of entry of and the spacing of the mixing channels are configured for the output of all mixing channels to collide in the mixing chamber and the collision of the mixing channel output is a multiple point collision resulting in a rotating output.

4. The generator of claim 1, wherein the housing, comprises: a singular gas opening.

5. The generator of claim 4, wherein the gas opening, further comprises:
a) a gas inlet fitting located on the exterior of the housing and in gas communication with the gas opening; and,
b) a circumferential gas sleeve configured to be in gas communication with the gas opening and each of the mixing chamber gas inlets.

6. The generator of claim 5, wherein the gas inlet fitting, comprises a barbed hose fitting.

7. The generator of claim 4, wherein the housing, comprises: a plurality of gas openings.

8. The generator of claim 6, wherein the gas opening, further comprises:
a) a gas channel connecting each opening with a mixing channel.

9. The generator of claim 1, wherein the top of the mixing chamber has a substantially convex conical shape.

10. The generator of claim 1, wherein the generator is in an in-line configuration.

11. The generator of claim 1, wherein the inlet and outlet each, independently, comprise: threading.

12. The generator of claim 1, wherein the liquid openings in the bottom of the upper chamber are substantially equidistant from one another.

13. The generator of claim 12, wherein the liquid openings in the bottom of the upper chamber are evenly spaced substantially throughout the bottom.

14. The generator of claim 1, wherein the generator is configured to discharge water, comprising: at least 100M/mL nanobubbles.

15. The generator of claim 1, wherein the diameters of the nanobubbles range from 10 to 1000 nm.
